(19) United States
(12) Patent Application Publication
(10) Pub. No.: US 2016/0055624 A1
(43) Pub. Date: Feb. 25, 2016

(54) DISPLAY DEVICE AND CONTROL METHOD THEREFOR

(71) Applicant: CANON KABUSHIKI KAISHA, Tokyo (JP)

(72) Inventor: Tomoyuki Ohno, Zama-shi (JP)

(21) Appl. No.: 14/820,790

(22) Filed: Aug. 7, 2015

(30) Foreign Application Priority Data
Aug. 25, 2014 (JP) 2014-170408

(51) Int. Cl. G06T 5/00; G06T 3/00; G06T 11/60; G09G 5/10; G09G 5/18

(52) U.S. Cl. CPC G06T 5/00; G09G 5/10; G09G 5/18; G06T 11/60; G06T 3/00

(57) ABSTRACT

Provided is a display device including an input unit configured to receive an input of first image data from an outside, a generating unit configured to generate second image data, a combining unit configured to combine the second image data with the first image data to generate display data, a display unit configured to display an image based on the display data, and a control unit configured to perform, when a fixed period elapses after an image based on the second image data is displayed on the display unit, control for changing display state of the image based on the second image data according to content of the second image data.

### BACKGROUND OF THE INVENTION

1. Field of the Invention

The present invention relates to a display device and a control method therefor.

2. Description of the Related Art

Some display devices include an on screen display (OSD) function besides displaying an image based on image data input from the outside of the device. The display device can display a menu screen with the OSD and perform operation such as image quality adjustment for a display image according to user operation of a main body button or the like. With the OSD, the display device can display format information such as the number of pixels and a frame rate of image data being displayed and display information concerning an error that has occurred in the display device. Some display devices for business use can perform marker display and time code display for checking an angle of view in an image and an object position in the image.

In a display device that tends to cause burning such as an organic electro-luminescence (EL) panel or a cathode-ray tube (CRT), in general, control for reducing the burning (burning reducing control) is performed. As the burning reducing control, there is control for reducing display brightness of the entire or a part of a display screen when the display device is not operated for a fixed time, erasing the OSD, or performing “pixel shift” for shifting a display position of the OSD (see Japanese Patent Application Laid-Open No. H8-248934).

However, when the OSD is, for example, marker display indicating the center of a frame, because of a purpose of use of the marker display, it is undesirable to perform the erasing or the pixel shift as the burning reducing control. This is because a relation between a display position of a marker and a display position of an image is important. When an angle of view of an image and an object position in the image are checked using the marker display, a rather long time is often required. In that case, the display device tends to be not operated for a fixed period. However, because of the purpose of use of the marker display, it is undesirable to reduce the brightness of the marker display as the burning reducing control.

### SUMMARY OF THE INVENTION

The present invention has been devised in view of the problems and it is an object of the present invention to perform appropriate burning reducing control in a display device having an OSD display function.

According to a first aspect of the present invention, there is provided a display device including: an input unit configured to receive an input of first image data from an outside; a generating unit configured to generate second image data; a combining unit configured to combine the second image data with the first image data to generate display data; a display unit configured to display an image based on the display data; and a control unit configured to perform, when a fixed period elapses after an image based on the second image data is displayed on the display unit, control for changing display state of the image based on the second image data according to content of the second image data.

According to a second aspect of the present invention, there is provided a control method for a display device including: receiving an input of first image data from the outside; generating second image data; combining the second image data with the first image data to generate display data; displaying an image based on the display data on a display unit; and performing, when a fixed period elapses after an image based on the second image data is displayed on the display unit, control for changing a display state of the image based on the second image data according to content of the second image data.

According to the present invention, it is possible to perform appropriate burning reducing control in a display image having an OSD display function.

Further features of the present invention will become apparent from the following description of exemplary embodiments with reference to the attached drawings.

### BRIEF DESCRIPTION OF THE DRAWINGS

FIG. 1 is a block diagram showing the main configuration of a display device according to a first embodiment;

FIGS. 2A to 2D are diagrams showing display examples of an OSD;

FIG. 3 is a flowchart for explaining operation according to the first embodiment;

FIG. 4 is an example of a burning reducing processing method determination table according to embodiments;

FIG. 5 is an example of processing for periodically changing a rendering pixel of marker display according to the first embodiment to a third embodiment;

FIG. 6 is a block diagram showing the main configuration of a display device according to the second embodiment;

FIG. 7 is a flowchart for explaining operation according to the second embodiment;

FIG. 8 is a block diagram showing the main configuration of a display device according to the third embodiment;

FIG. 9 is a flowchart for explaining operation according to the third embodiment; and

FIG. 10 is an example of processing for periodically changing a rendering pixel of marker display.

### DESCRIPTION OF THE EMBODIMENTS

Exemplary embodiments of the present invention are explained below.

### First Embodiment

A first embodiment of the present invention is explained below with reference to the drawings.

In the first embodiment, an example is explained in which suitable burning reducing control is realized for each OSD type to be displayed.

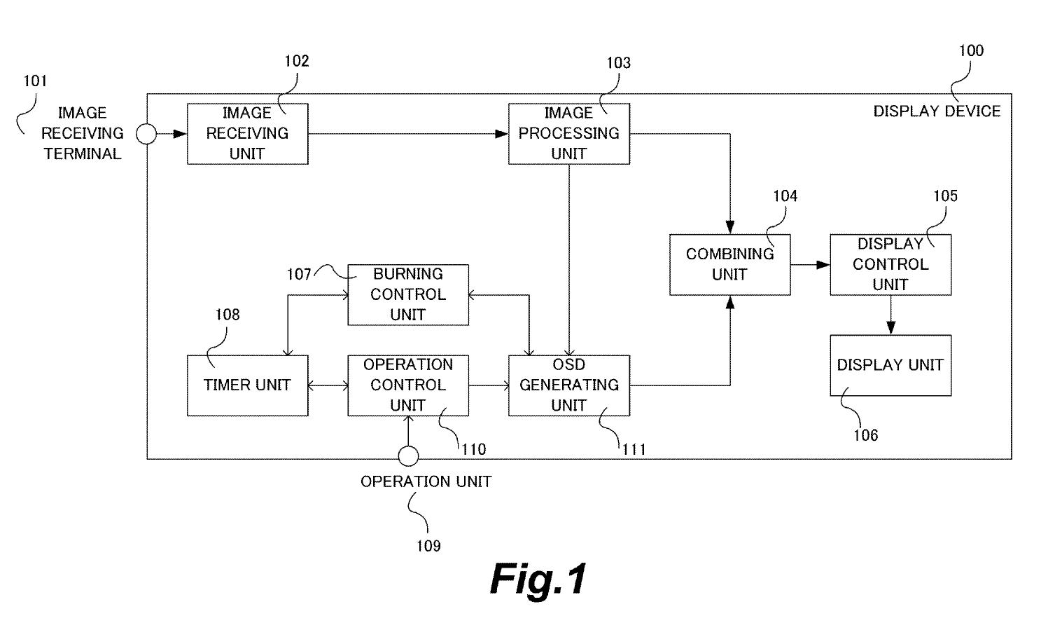

FIG. 1 is a block diagram showing the main configuration of a display device 100 according to the first embodiment of the present invention.

The display device 100 shown in FIG. 1 includes an image receiving terminal 101, an image receiving unit 102, an image processing unit 103, a combining unit 104, a display control unit 105, a display unit 106, a burning control unit 107, a timer unit 108, an operation unit 109, an operation control unit 110, and an OSD generating unit 111.

First image data is input to the display device 100 from a not-shown external image data source via the image receiving terminal 101.

The display unit 106 displays an image based on the input first image data.

Besides displaying the image based on the input first image data, the display device 100 displays an image based on image data generated by combining second image data including various contents retained or generated on the inside of the display device 100 with the first image data. The first image data is a normal image input from an external image output apparatus. The second image data is an image for performing OSD display.

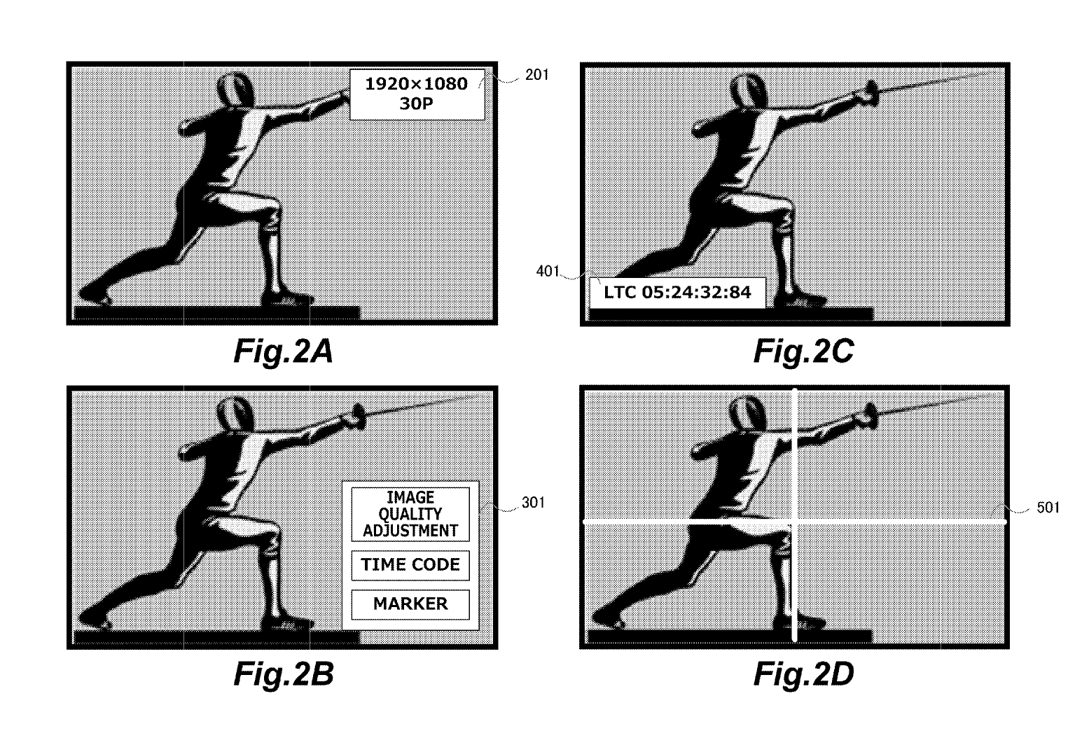

The display device 100 is capable of displaying, as the OSD, a banner for displaying format information of input image data, a menu, a time code, a waveform monitor, a vector scope, a focus assist, a zebra pattern, a marker indicating a position in a frame, and the like. The OSD generating unit 111 generates the second image data for the OSD displays. Display examples of the OSD are shown in FIGS. 2A to 2D. Reference numeral 201 in FIG. 2A denotes an example of a signal information banner. Reference numeral 301 in FIG. 2B denotes an example of the menu. Reference numeral 401 in FIG. 2C denotes an example of the time code. Reference numeral 501 in FIG. 2D denotes an example of the marker.

The signal information banner is OSD display for notifying a user of a format (resolution (the number of pixels) and a frame rate, etc.) of image data received by the image receiving unit 102. The signal information banner is displayed immediately after the start of image display and erased after the elapse of a fixed period (e.g., after being displayed for 5 seconds).

The menu screen is a screen for the user to perform function setting for the display device 100. The menu screen is started to be displayed according to operation of the operation unit 109 by the user and is erased when the operation unit 109 is not operated for a fixed time (e.g. 30 seconds).

The time code is time axis information recorded in image data as incidental information of the image data. For example, the time code is recorded in a form of “hour: minute: second: frame”. When the time code information is displayed together with an image, the user can see a position on a time axis of an image being displayed and easily carry out image editing and the like.

The marker display is display for checking an angle of view of an image, an object position in the image, a center position in a frame, and the like. The time code and the marker display are not erased even when the operation unit 109 is not operated for a fixed time (e.g., 30 seconds).

The operation unit 109 includes a plurality of buttons (not shown in the figure). The user can perform menu screen operation for performing power ON/OFF operation of the display device 100 and function setting for the display device 100 by operating the buttons. The user can operate the operation unit 109 while viewing the menu screen to display the time code and the marker included in the display device 100.

(Basic Operation)

The basis operation of the display device 100 is explained.

The display device 100 is started according to operation of a power button (in the operation unit 109; not shown in the figure) by the user. After the start, the image receiving unit 102 receives, via the image receiving terminal 101, an image signal from a not-shown external image signal source. In the image receiving terminal 101 of the display device 100, a serial digital interface (SDI) specified by society of motion picture and television engineers (SMPTE) is used. The image receiving terminal 101 is an example and is not limited to this.

The image processing unit 103 converts a received image signal into image data of a predetermined format (resolution, the number of bits, and a frame rate). In the first embodiment, the image processing unit 103 converts the image signal into image data having horizontal×vertical resolution: 1920×1080, the number of bits: 10 bits for colors of RGB, the frame rate: 60 Hz. The operation of the combining unit 104 is explained below. The format of the image data is an example and is not limited to this.

The display control unit 105 converts the image data into display data suitable for display resolution, the number of display bits, and a frame rate of the display unit 106 and transmits the display data to the display unit 106. The display unit 106 displays an image on the basis of the image data transmitted by the display control unit 105. An organic electro-luminescence (EL) panel is use as the display unit 106. Note that the display unit 106 is not limited to the organic EL panel and may be a liquid crystal panel, micro electro mechanical systems (MEMS) panel, or the like. When image data of a format that the display device 100 cannot display is input, the display unit 106 displays a black image on the entire screen.

(OSD: Display Operation for the Signal Information Banner)

Display operation for the signal information banner is explained.

After the display unit 106 starts to display the image based on the image data, the OSD generating unit 111 performs display control for the signal information banner displayed on the display unit 106. When acquiring, from the image processing unit 103, format information of the image data received by the image receiving unit 102, the OSD generating unit 111 generates OSD data including the format information. The combining unit 104 combines the generated OSD data with the image data converted by the image processing unit 103 to generate display data. The display unit 106 displays an image based on the display data generated by the combining unit 104.

When the display of the signal information banner is started on the display unit 106, the OSD generating unit 111 notifies the burning control unit 107 of information indicating an OSD type (content) being displayed. The OSD generating unit 111 notifies the burning control unit 107 that the OSD being displayed is the “signal information banner”. When receiving the notification, the burning control unit 107 performs information registration for causing the timer unit 108 to perform notification (burning timer notification) when a fixed time elapses after the start of the OSD display. The burning timer notification is used for timing control of the start of the operation of the burning reducing processing. The burning control unit 107 retains registration information of the burning timer notification and OSD type information in association with each other.

(OSD: Display Operation for the Menu Screen)

Display operation for the menu screen is explained.

The menu screen is started to be displayed according to operation of a menu operation button (in the operation unit 109, not shown in the figure) by the user. When detecting the menu button operation, the operation control unit 110 requests the OSD generating unit 111 to display the menu screen. When receiving the request for the menu display screen, the OSD generating unit 111 generates OSD data. The combining unit 104 combines the generated OSD data with the image data to generate display data. The display control unit 105 outputs the display data to the display unit 106. The display unit 106 displays the menu screen on the basis of the display data.

When the display of the menu screen is started in the display unit 106, the OSD generating unit 111 notifies the burning control unit 107 of the OSD type information being displayed. The OSD generating unit 111 notifies the burning control unit 107 that the OSD being displayed is an “OSD menu”.

As explained above, the user can operate the operation unit 109 while viewing the menu screen display to perform function setting for the display device 100. When detecting that the menu screen operation by the user is performed from the operation unit 109, the operation control unit 110 requests the OSD generating unit 111 to update the menu screen. When receiving the update request for the menu screen, the OSD generating unit 111 generates new OSD data. The combining unit 104 and the display control unit 105 perform processing same as the processing explained above. A menu screen based on the OSD data after the update is displayed on the display unit 106. When the display of the menu screen is updated on the display unit 106, the OSD generating unit 111 notifies the burning control unit 107 of the OSD type information being displayed. The OSD generating unit 111 notifies the burning control unit 107 that the OSD being displayed is the “OSD menu”. When receiving the notification, the burning control unit 107 performs, in association with the OSD type information, information registration for causing the timer unit 108 to perform notification (burning timer notification) when a fixed time elapses after the start of the OSD display. The burning timer notification is used for timing control of the start of the operation of the burning reducing processing.

(OSD: Display Operation for the Time Code)

Display operation for the time code is explained.

The time code is started to be displayed according to the operation of the operation unit 109 by the user during the menu screen display. When detecting the operation of the operation unit 109 by the user and determining that an instruction input by the user operation is time code display, the operation control unit 110 requests the OSD generating unit 111 to erase the display of the menu screen and display the time code. When acquiring time code information included in the image data received by the image receiving unit 102 from the image processing unit 103, the OSD generating unit 111 generates OSD data including the time code information. The combining unit 104 combines the generated OSD data with the image data converted by the image processing unit 103 to generate display data. The display unit 106 displays an image based on the display data generated by the combining unit 104.

When the display of the time code is started on the display unit 106, the OSD generating unit 111 notifies the burning control unit 107 of the OSD type information being displayed. The OSD generating unit 111 notifies the burning control unit 107 that the OSD type information being displayed is the “time code”. When receiving the notification, the burning control unit 107 performs, in association with the OSD type information, information registration for causing the timer unit 108 to perform notification (burning timer notification) when a fixed time elapses after the start of the OSD display. The burning timer notification is used for timing control of the start of the operation of the burning reducing processing.

(OSD: Display Operation for the Marker)

Display operation for the marker is explained.

The marker is started to be displayed according to operation of the operation unit 109 by the user during the menu screen display. When detecting the operation of the operation unit 109 by the user and determining that an instruction input by the user operation is marker display, the operation control unit 110 requests the OSD generating unit 111 to erase the display of the menu screen and display the marker. The OSD generating unit 111 generates OSD data for marker display. The combining unit 104 combines the generated OSD data with the image data converted by the image processing unit 103 to generate display data. The display unit 106 displays an image based on the display data generated by the combining unit 104.

When the display of the marker is started on the display unit 106, the OSD generating unit 111 notifies the burning control unit 107 of the OSD type information being displayed. The OSD generating unit 111 notifies the burning control unit 107 that the OSD type information being displayed is the “marker”. When receiving the notification, the burning control unit 107 performs, in association with the OSD type information, information registration for causing the timer unit 108 to perform notification (burning timer notification) when a fixed time elapses after the start of the OSD display. The burning timer notification is used for timing control of the start of the operation of the burning reducing processing. The burning control unit 107 retains registration information of the burning timer notification and the OSD type information in association with each other.

(Burning Reducing Processing: The Operation of the Burning Control Unit 107)

The burning reducing processing is explained below. The burning reducing processing is started by being triggered by the reception of the burning timer notification notified from the timer unit 108 to the burning control unit 107. The burning timer notification includes the OSD type information associated during the registration.

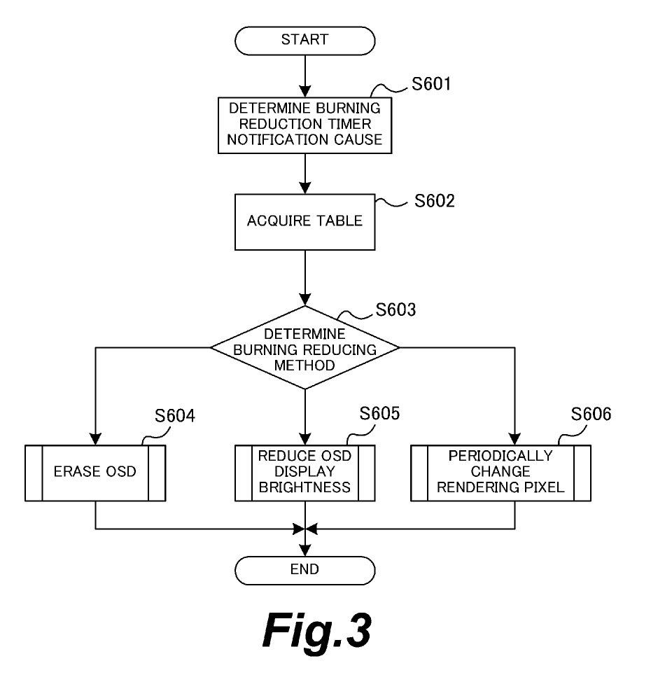

FIG. 3 is a flowchart for explaining the burning reducing processing in the first embodiment.

### (S601)

In S601, when receiving the burning timer notification from the timer unit 108, the burning control unit 107 determines a cause of the notification. The burning control unit 107 performs the determination of the cause of the notification on the basis of the OSD type information included in the burning timer notification. The burning timer notification is notified by the timer unit 108 when a fixed period elapses after any OSD is started to be displayed. The determination of the cause of the notification means that a type (content) of the OSD displayed for the fixed period after the start of the display.

### (S602)

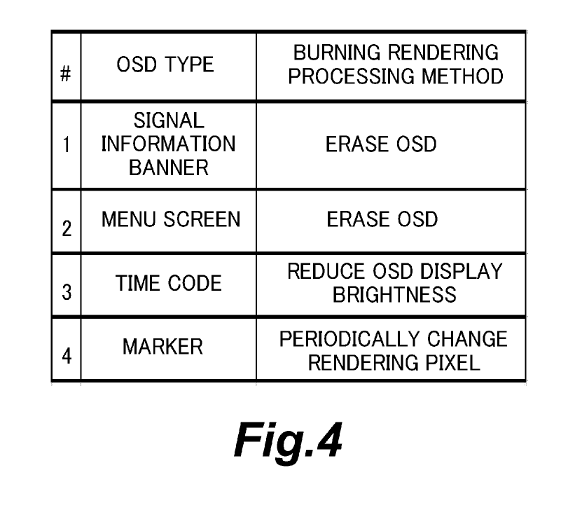

In S602, the burning control unit 107 acquires a table for determining a method of the burning reducing processing. An example of the table is shown in FIG. 4. The table is a table in which information concerning a predetermined correspondence relation between an OSD type (content of OSD) and a burning reducing processing method, which is a method of changing a display state of the OSD when a fixed time elapses from the start of the display of the OSD, is described. In the first embodiment, the table is recorded in a nonvolatile memory (not shown in the figure) in the display device 100.

### (S603)

In S603, the burning control unit 107 selects and determines the burning reducing processing method on the basis of the burning timer notification cause determined in S601 and the table acquired in S602.

For example, when the burning timer notification cause is the “signal information banner” or the “menu screen”, the burning control unit 107 selects and determines “OSD erasing” as the burning reducing processing. When the burning timer notification cause is the “time code”, the burning control unit 107 selects and determines processing for “reducing OSD display brightness” as the burning reducing processing. When the burning timer notification cause is the “marker”, the burning control unit 107 selects and determines processing for “periodically changing a rendering pixel” as the burning reducing processing.

### (S604): OSD Erasing

In S604, the burning control unit 107 requests the OSD generating unit 111 to erase, together with the OSD type information, the OSD being displayed. When the OSD type information is the “signal information banner”, only the signal information banner being displayed is erased. When the OSD type information is the “menu screen”, only the menu screen being displayed is erased. Examples of the OSD, for which the suitable method for changing the display state after the elapse of a fixed period from the start of the OSD display is erasing display, include the format information of image data or the menu. The signal information banner and the menu screen for displaying the format information are explained as an example above. Note that the method of the change of the display state of the OSD displays may be a change in a display position instead of the erasing of the display. This is because a display position in a frame of the OSD displays is not important compared with, for example, the marker display.

### (S605): Reduce the OSD Display Brightness

In S605, the burning control unit 107 requests the OSD generating unit 111 to reduce, together with the OSD type information, the brightness of the OSD being displayed. The OSD generating unit 111 generates again OSD data in which the display brightness of the OSD decreases. The combining unit 104 combines the generated OSD data with the image data converted by the image processing unit 103 to generate display data. An image based on the display data generated by the combining unit 104 is displayed on the display unit 106. When the OSD type information is the “time code”, the display brightness of only a display region of the time code decreases. As the OSD, the display brightness of which is suitably reduced, the waveform monitor, the vector scope, and the like can be illustrated.

(S606): Periodically Change a Rendering Pixel

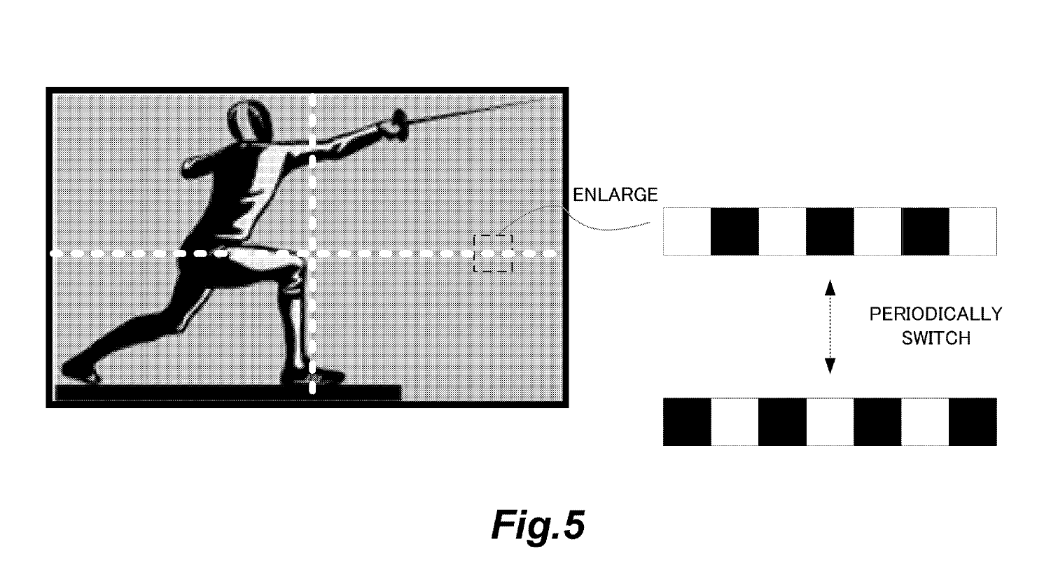

In S606, the burning control unit 107 requests the OSD generating unit 111 to execute processing for periodically changing, together with the OSD type information, a rendering pixel of the OSD being displayed. Changing the rendering pixel of the OSD means reducing the brightness of a part of pixels configuring an image of the OSD or erasing the part of the pixels. Periodically changing the rendering pixel means periodically changing, among the pixels configuring the image of the OSD, the pixel of which brightness is to be reduced, or the pixel to be erased. FIG. 5 is a diagram schematically showing an example of the processing periodically changing the rendering pixel of the marker display being displayed. In an example shown in FIG. 5, rendering portions of the marker display are alternately periodically switched pixel by pixel to perform rendering. If the burning reducing processing for alternately periodically switching the rendering portions pixel by pixel to perform rendering is performed, a relation between a display position of a marker and a display position of an image does not change. Therefore, work of the user for checking an angle of view of the image and an object position in the image is not hindered. Note that a period for periodically switching the rendering portions is optional as long as burning can be suitably suppressed. For example, the period can be set to a five-second interval or a ten-second interval. When the OSD type information is the “marker display”, processing for periodically changing the rendering pixel by reducing the brightness of a part of the pixels configuring the marker display or erasing the part of the pixels is performed. As the OSD for which such burning reducing processing is suitable, the marker indicating a position in a frame, the focus assist, the zebra pattern, and the like can be illustrated. A positional relation between the OSD displays and an image based on first image data input from the outside is important. The burning reducing processing cannot be performed by the method of changing the display position. However, burning reduction can be suitably performed by performing processing for periodically changing the rendering pixel.

According to the first embodiment, when the fixed period elapses after the image based on the second image data generated on the inside is displayed on the display unit, the control for changing the display state of the image based on the second image data according to the content (the type) of the second image data is performed. As the second image data, the image data configuring the image of the OSD is particularly illustrated. The correspondence relation between the content (the type) of the second image data and the method of changing the display state is decided in advance and stored in the table. A suitable burning reducing processing method is determined for each of described OSD types. Consequently, in a display for image production, it is possible to realize burning reducing control suitable for a purpose of each of the displayed OSD types.

### Second Embodiment

A second embodiment of the present invention is explained below with reference to the drawings.

In the first embodiment, the example is explained in which the suitable burning reducing processing is controlled for each of the OSD types such as the “signal information banner”, the “menu screen”, the “time code”, and the “marker”. In the second embodiment, an example is explained in which burning reducing processing is controlled further on the basis of presence or absence of an input of image data (first image data) to a display device from the outside.

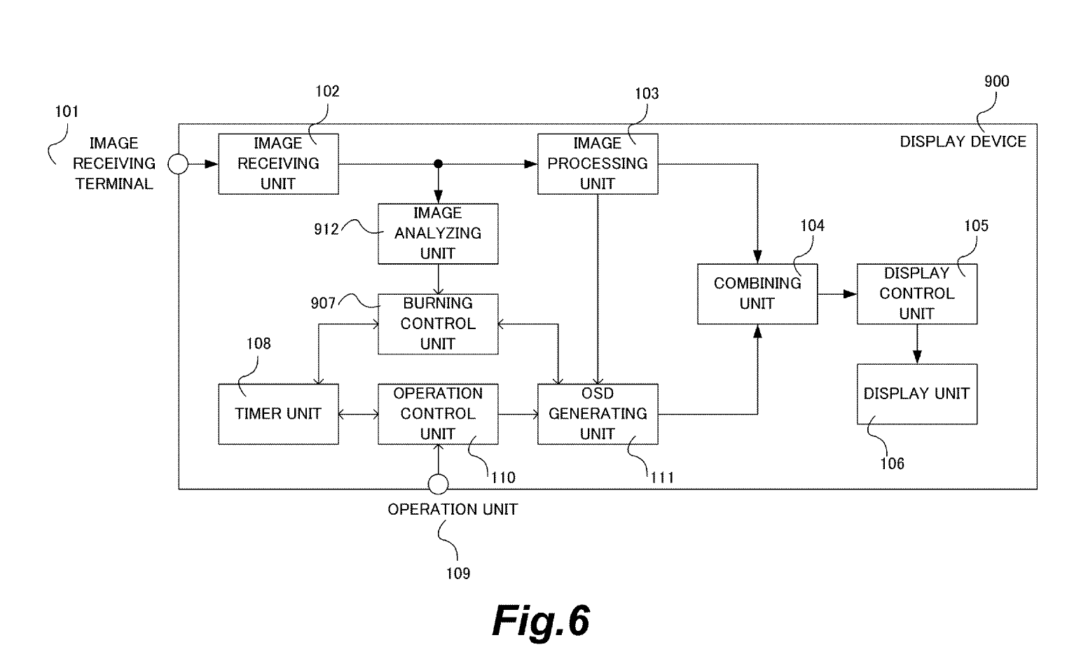

FIG. 6 is a block diagram showing the main configuration of a display device 900 according to the second embodiment of the present invention. Blocks denoted by reference numerals same as the reference numerals of the blocks shown in FIG. 1 have action same as the action of the blocks explained in the first embodiment. Action of an image analyzing unit 912 and a burning control unit 907 is explained below.

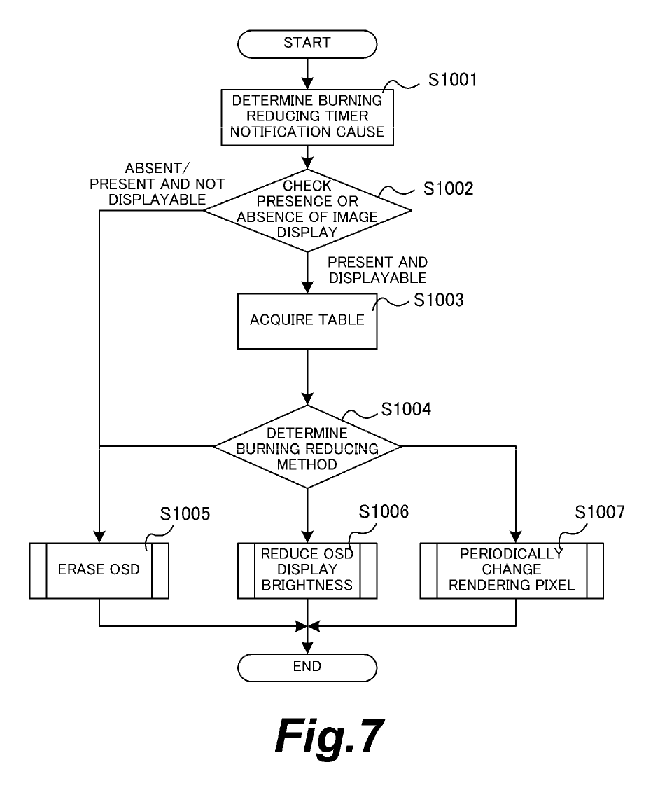

FIG. 7 is a flowchart for explaining burning reducing processing in the second embodiment.

### (S1001)

Processing in S1001 is the same as the processing in S601 in the first embodiment. Therefore, explanation of the processing is omitted.

### (S1002)

In S1002, the image analyzing unit 912 analyzes and determines whether image data is input to the image receiving unit 102 and, when image data is input, whether the image data is image data of a format displayable by the display device 900. The image analyzing unit 912 notifies the burning control unit 907 of a result of the determination as input image information. When no image data is input or when image data is input but the image data is image data of a format not displayable by the display device 900, the image analyzing unit 912 notifies the burning control unit 907 of “signal is not input or not displayable” as the input image information and proceeds to S1005. When the image data displayable by the display device 900 is input, the image analyzing unit 912 notifies the burning control unit 907 of “signal is input and displayable” as the input image information and proceeds to S1004.

### (S1003)

Processing of the burning control unit 907 in S1003 is the same as the processing of the burning control unit 107 in S602 in the first embodiment. Therefore, explanation of the processing is omitted.

### (S1004)

In S1004, the burning control unit 907 selects and determines a burning reducing processing method on the basis of the burning timer notification cause determined in S1001, the input image information notified in S1002, and the table acquired in S1003.

When the input image information is “image data is input and not displayable”, the burning control unit 907 selects and determines “OSD erasing” as the burning reducing processing. In this case, instead of erasing display of OSD, burning reducing processing for changing a position for displaying an image of the OSD may be performed.

When the input image information is “image data is input and displayable” and the burning timer notification cause is the “signal information banner” or the “menu screen”, the burning control unit 907 selects and determines the “OSD erasing” as the burning reducing processing. When the burning timer notification cause is the “time code”, the burning control unit 907 selects processing for “reducing OSD display brightness”. When the burning timer notification cause is the “marker”, the burning control unit 907 selects processing for “periodically changing a rendering pixel”.

### (S1005 to S1007)

Processing in S1005 to S1007 is the same as the processing in S604 to S606 in the first embodiment. Therefore, explanation of the processing is omitted.

In the second embodiment, a burning reducing processing method suitable for each of OSD types is determined on the basis of presence or absence of an input of image data to the display device from the outside, information concerning whether input image data is displayable, and OSD type information being displayed. Consequently, it is possible to perform burning reduction suitable for each of OSD types to be displayed.

### Third Embodiment

A third embodiment of the present invention is explained below with reference to the drawings.

In the first embodiment, the example is explained in which the suitable burning reducing processing is performed for each of the OSD types such as the “signal information banner”, the “menu screen”, the “time code”, and the “marker”. In the third embodiment, an example is explained in which burning reducing processing is controlled further on the basis of whether time code information is included in input image data.

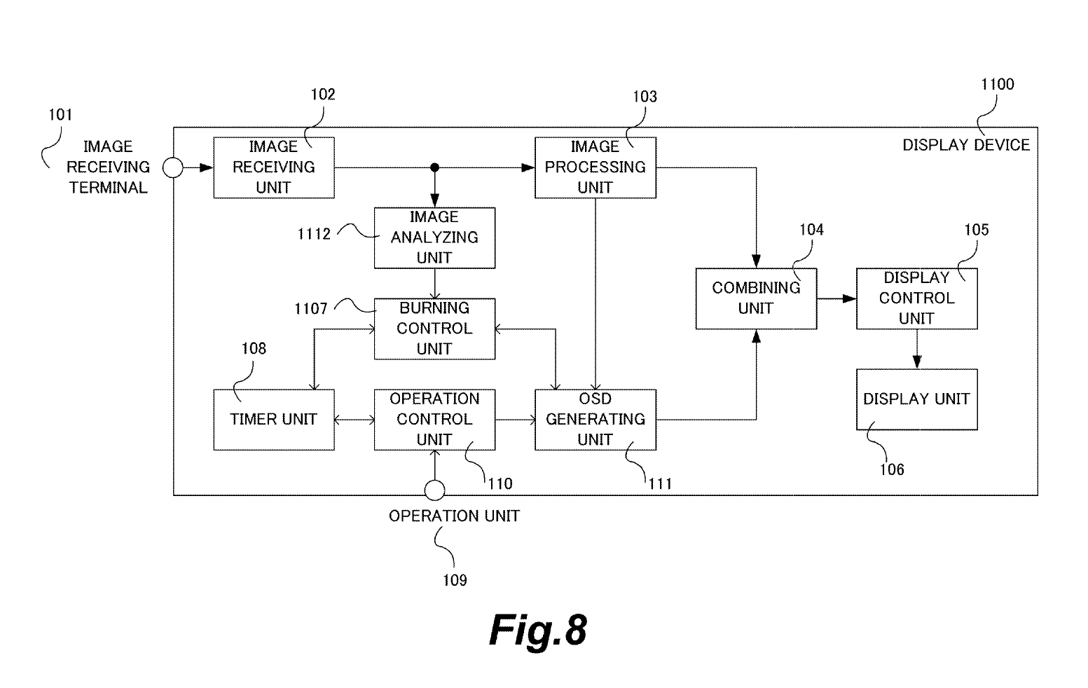

FIG. 8 is a block diagram showing the main configuration of a display device 1100 according to the third embodiment of the present invention. Blocks denoted by reference numerals same as the reference numerals of the blocks shown in FIG. 6 have action same as the action of the blocks explained in the second embodiment. Action of an image analyzing unit 1112 and a burning control unit 1107 is explained below.

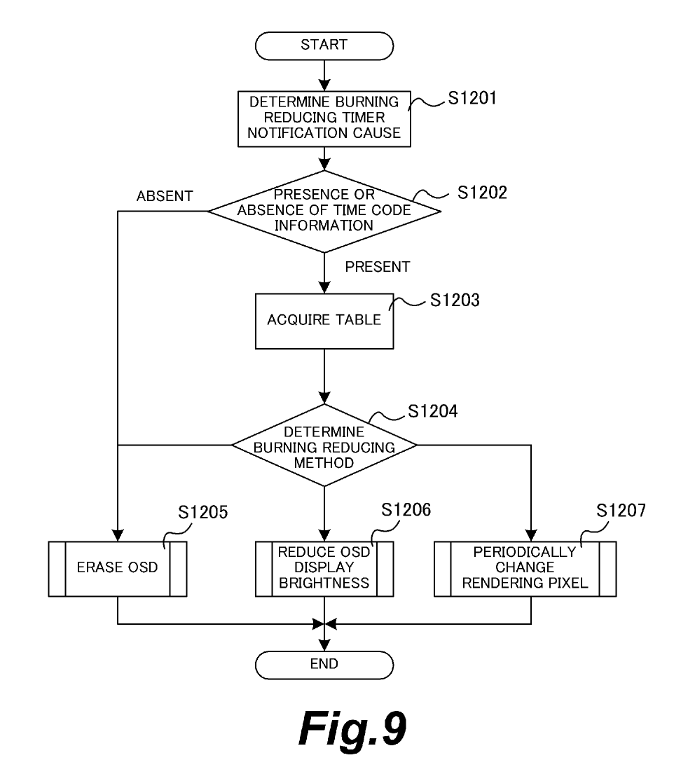

FIG. 9 is a flowchart for explaining burning reducing processing in the third embodiment.

### (S1201)

Processing in S1201 is the same as the processing in S1001 in the second embodiment. Therefore, explanation of the processing is omitted.

### (S1202)

In S1202, the image analyzing unit 1112 analyzes and determines whether time code information is included in image data input to the image receiving unit 102. The image analyzing unit 1112 notifies the burning control unit 1107 of a result of the determination as time code presence or absence information. When time code information is not included, the image analyzing unit 1112 notifies the burning control unit 1107 of the time code presence or absence information “absent” and proceeds to S1205. When time code information is included, the image analyzing unit 1112 notifies the burning control unit 1107 of the time code presence or absence information “present” and proceeds to S1204.

### (S1203)

Processing of the burning control unit 1107 in S1203 is the same as the processing of the burning control unit 907 in S1003 in the second embodiment. Therefore, explanation of the processing is omitted.

### (S1204)

In S1204, the burning control unit 1107 selects and determines a burning reducing processing method on the basis of the burning timer notification cause determined in S1201, the time code presence or absence information notified in S1202, and the table acquired in S1203.

When the burning timer notification factor is the “signal information banner” or the “menu screen”, the burning control unit 1107 selects and determines the “OSD erasing” as the burning reducing processing. When the burning timer notification cause is the “time code” and the time code presence or absence information is “present”, the burning control unit 1107 selects and determines processing for “reducing OSD display brightness”. Note that, when the burning timer notification cause is the “time code” and the time code presence or absence information is “absent”, S1205 is executed according to a condition branch in S1202. The “OSD erasing” is selected as the burning reducing processing. In this case, instead of erasing the display of the OSD, burning reducing processing for changing a position where an image of the OSD is displayed may be performed.

When the burning timer notification cause is the “marker”, the burning control unit 1107 selects and determines processing for “periodically change a rendering pixel”.

### (S1205 to S1207)

Processing in S1205 to S1207 is the same as the processing in S1005 to S1007 in the first embodiment. Therefore, explanation of the processing is omitted.

According to the third embodiment, it is possible to execute suitable burning reducing processing for each of OSD types on the basis of information indicating presence or absence of a time code in incidental information of an input image and OSD type information being displayed. Consequently, it is possible to perform suitable burning reducing processing for each of OSD types to be displayed.

### Other Embodiments

In the explanation in the embodiments explained above, the signal information banner is displayed immediately after the start of the image display and erased after the elapse of the fixed time (e.g., 5 seconds). It is also possible to continue to display the signal information banner according to setting of the display device. As the burning reducing processing in that case, the “pixel shift” explained in the background art may be applied rather than the “OSD erasing”.

In the embodiments, the processing for “periodically changing the rendering pixel” is explained as the example of the burning reducing control in the case of the marker display. After the processing for “periodically changing the rendering pixel” is carried out, when there is no movement in the display image on the display unit, the processing may be switched to the processing for “reducing OSD display brightness” to perform the burning reducing control. Alternatively, the processing for “periodically changing the rendering pixel” and the processing for “reducing OSD display brightness” may be combined to carry out the burning reducing control. For example, in FIG. 5, the example is shown in which display for each one pixel and non-display are switched. However, brightness may be changed stepwise until a pixel in a display state is changed to a non-display state or a pixel in the non-display state is changed to the display state. As a scene in which there is no movement in a display image, for example, it is assumed that image data of a not-shown external image data source is input in a suspended (standstill) state. The burning reducing control may be performed to reduce brightness only in a portion not updated for display in OSD. For example, in the time code display shown in FIG. 2C, a character string “LTC” and a delimiter “:” of numbers representing hour and minute are not updated for display. The numbers representing hour and minute are updated for display. Therefore, the burning reducing control for reducing the brightness of only the “LTC” and “:” portions and maintaining the brightness of the number portion may be performed.

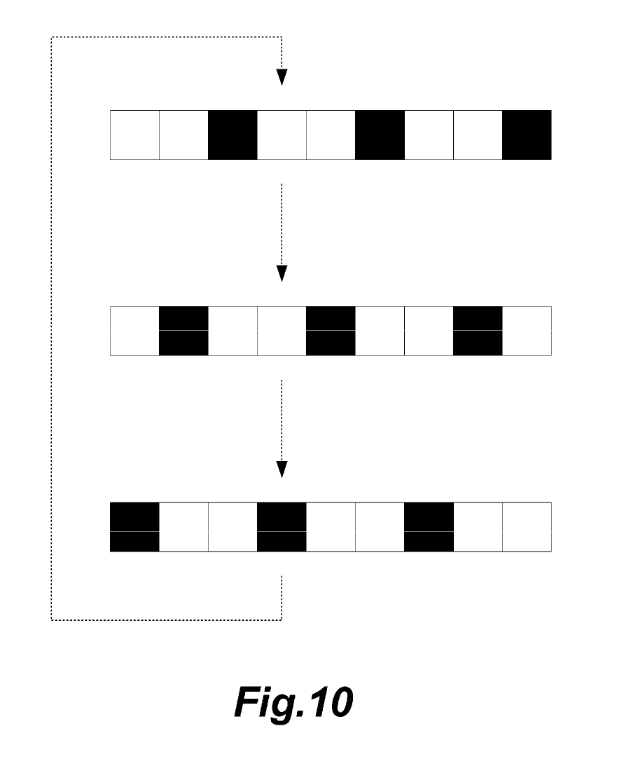

In the first embodiment, as the processing for “periodically changing the rendering pixel” performed as the burning reducing processing in the case of the marker display, the example is explained in which the rendering portions of the marker display is alternately periodically switched pixel by pixel to perform rendering as shown in the example in FIG. 5. Pixels periodically switched and rendered are not limited to be alternately switched pixel by pixel. As shown in FIG. 10, the pixels may be rendered by lighting two pixels and not lighting one pixel.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2014-170408, filed on Aug. 25, 2014, which is hereby incorporated by reference herein in its entirety.

What is claimed is:

1. A display device comprising:
an input unit configured to receive an input of first image data from an outside;
a generating unit configured to generate second image data;
a combining unit configured to combine the second image data with the first image data to generate display data;
a display unit configured to display an image based on the display data; and
a control unit configured to perform, when a fixed period elapses after an image based on the second image data is displayed on the display unit, control for changing display state of the image based on the second image data according to content of the second image data.

2. The display device according to claim 1, wherein the control unit acquires information concerning a predetermined correspondence relation between the content of the second image data and a way of changing the display state of the image based on the second image data, and changes the display state of the image based on the second image data on the basis of the correspondence relation and information concerning the content of the second image data acquired from the generating unit.

3. The display device according to claim 1, wherein the control unit changes the display state of the image based on the second image data by changing brightness of the image based on the second image data.

4. The display device according to claim 1, wherein, when the content of the second image data is format information of the first image data or a menu, the control unit changes the display state of the image based on the second image data by erasing the image based on the second image data or changing a position where the image based on the second image data is displayed.

5. The display device according to claim 1, wherein, when the content of the second image data is a time code of the first image data, a waveform monitor, or a vector scope, the control unit changes the display state of the image based on the second image data by reducing brightness of the image based on the second image data.

6. The display device according to claim 1, wherein, when the content of the second image data is a marker indicating a position in a frame, a focus assist, or a zebra pattern, the control unit changes the display state of the image based on the second image data by reducing brightness of a part of pixels of the image based on the second image data or erasing the part of the pixels.

7. The display device according to claim 6, wherein the control unit periodically changes, among the pixels configuring the image based on the second image data, the pixel of which brightness is to be reduced, or the pixel to be erased.

8. The display device according to claim 1, wherein the control unit performs control for changing the display state of the image based on the second image data further on the basis of presence or absence of the input of the first image data to the input unit.

9. The display device according to claim 8, wherein, when the first image data is not input to the input unit or when the first image data is input but is image data of a format not displayable on the display unit, the control unit changes the display state of the image based on the second image data by erasing the image based on the second image data or changing a position where the image based on the second image data is displayed.

10. The display device according to claim 1, wherein the control unit performs control for changing the display state of the image based on the second image data further on the basis of whether time code information is included in the first image data input to the input unit, and the control unit changes the display state of the image based on the second image data by erasing the image based on the second image data or changing a position where the image based on the second image data is displayed when the time code information is not included, whereas by reducing brightness of the image based on the second image data when the time code information is included and the content of the second image data is a time code of the first image data.

11. A control method for a display device comprising:
receiving an input of first image data from an outside;
generating second image data;
combining the second image data with the first image data to generate display data;
displaying an image based on the display data on a display unit; and
performing, when a fixed period elapses after an image based on the second image data is displayed on the display unit, control for changing display state of the image based on the second image data according to content of the second image data.

12. The control method for a display device according to claim 11, wherein, in the performing of the control, information concerning a predetermined correspondence relation between the content of the second image data and a way of changing the display state of the image based on the second image data is acquired, and the display state of the image based on the second image data is changed on the basis of the correspondence relation and information concerning the content of the acquired second image data.

13. The control method for a display device according to claim 11, wherein, in the performing of the control, the display state of the image based on the second image data is changed by changing brightness of the image based on the second image data.

14. The control method for a display device according to claim 11, wherein, in the performing of the control, when the content of the second image data is format information of the first image data or a menu, the display state of the image based on the second image data is changed by erasing the image based on the second image data or changing a position where the image based on the second image data is displayed.

15. The control method for a display device according to claim 11, wherein, in the performing of the control, when the content of the second image data is a time code of the first image data, a waveform monitor, or a vector scope, the display state of the image based on the second image data is changed by reducing brightness of the image based on the second image data.

16. The control method for a display device according to claim 11, wherein, in the performing of the control, when the content of the second image data is a marker indicating a position in a frame, a focus assist, or a zebra pattern, the display state of the image based on the second image data is changed by reducing brightness of a part of pixels of the image based on the second image data or erasing the part of the pixels.

17. The control method for a display device according to claim 16, wherein, in the performing of the control, among the pixels configuring the image based on the second image data, the pixel of which brightness is to be reduced, or the pixel to be erased is periodically changed.

18. The control method for a display device according to claim 11, wherein, in the performing of the control, control for changing the display state of the image based on the second image data is performed further on the basis of presence or absence of the input of the first image data.

19. The control method for a display device according to claim 18, wherein, in the performing of the control, when the first image data is not input or when the first image data is input but is image data of a format not displayable on the display unit, the display state of the image based on the second image data is changed by erasing the image based on the second image data or changing a position where the image based on the second image data is displayed.

20. The control method for a display device according to claim 11, wherein, in the performing of the control, control for changing the display state of the image based on the second image data is performed further on the basis of whether time code information is included in the first image data that has been input, and the display state of the image based on the second image data is changed by erasing the image based on the second image data or changing a position where the image based on the second image data is displayed when the time code information is not included, whereas by reducing brightness of the image based on the second image data when the time code information is included and the content of the second image data is a time code of the first image data.
